(19) United States
(12) Patent Application Publication
(10) Pub. No.: US 2008/0191447 A1
(43) Pub. Date: Aug. 14, 2008

(54) CycleCar

(76) Inventor: Jeffrey Richard Nowakowski, Mandeville, LA (US)

Correspondence Address: Jeffrey R. Nowakowski, 614 Yupon Place, Mandeville, LA, 70471, US

(21) Appl. No.: 11/704,921

(22) Filed: Feb. 12, 2007

(51) Int. Cl. B62K 5/00; B60J 7/00

(52) U.S. Cl. 280/267; 135/88.03; 280/282; 296/203.01

(57) ABSTRACT

A human powered vehicle of the pedal-driven type having four wheels, a composite monocoque chassis, four wheel independent suspension, and seat for supporting one or more occupant/driver/riders in a generally supine position, and an aerodynamic chassis enclosure with a transparent canopy which is openable for entry and egress of the rider. The preferred embodiment for a single rider has two steerable wheels located forward of the rider, and two fixed drive wheels positioned behind the rider. The drive wheel is equipped with a multi-sprocket gearing arrangement, and a large pedal-equipped sprocket wheel is mounted in a position slightly forward and above the common axis of the front wheels for the rider's feet. A single drive chain extends from the drive sprocket to the sprocket cluster and passes under/over idler rollers which direct the chain beneath the rider.

Accordingly, the vehicle's chassis, suspension, and propulsion systems can be utilized on an enclosed track for exercise, recreation, and to simulate the sport of car racing.

### BACKGROUND OF THE INVENTION

1. Field of the Invention

This invention relates to human powered or pedal-type vehicles, such as bicycles, tricycles, quadricycles, and more particularly relates to such vehicles having an aerodynamic, composite monocoque chassis for reducing wind resistance and improving performance.

2. Description of the Prior Art

With the current trend of increasing cost of fuels for vehicle propulsion, it becomes appropriate to seriously consider the feasibility of human powered vehicles as commuting vehicles. However, despite the clear need for such use of human powered vehicles, the commuter field has scarcely been penetrated. Only a few of the more serious human powered enthusiasts use such vehicles for commuting to and from work, and then only for short distances of ten miles or less. Human powered vehicles remain un-feasible as commuter vehicles.

However, a human powered vehicle would be better accepted and used for exercise, recreation, and/or race events, much as bicycles are used today, if it is driven on a stationary, uniform, oval-shaped track, similar to a velodrome, rather than compete against two-ton motor vehicles on crumbling streets.

In a nation where obesity is rapidly becoming the number one health threat, there exists a need for a lightweight, stable, low-impact, inexpensive, human powered vehicle that will provide enjoyable exercise.

The sport of race car driving utilizes a high-powered vehicle that rapidly accelerates, decelerates, brakes, and turns over a fixed course. The driver must navigate the course at the highest speed, compete with other drivers, and complete a set number of laps in order to win.

Race car driving is an expensive, competitive, and highly popular sport. However, there exists a need for an inexpensive vehicle that accurately simulates race car driving wherein the operator/driver experiences the thrill of racing while maintaining control of the vehicle.

The present invention utilizes the aerodynamic, composite monocoque chassis of race cars, driveability of the multi-link, independent suspension of today's sports cars, and the bicycle's conventional, multi-gear propulsion system to provide a new form of exercise and a new niche sport.

Because the basic power source of a human powered vehicle is limited, the speed such a vehicle can obtain is a function of the total drag presented at different speeds. The higher the total drag characteristics of the man/machine combination, the more limited the speed.

Total drag on any rolling vehicle is equal to rolling wheel drag plus aero drag. Despite its sophistication in mechanical design, the present conventional design and development have not addressed the problem of aero drag. At best, the conventional bicycle provides a layout of frame, seat and handle bars which calls for the rider to assume a rather severely humped-over position. While this reduces drag to a slight extent, it is also quite uncomfortable and is acceptable only to racers and the more serious cycling afficionados.

Conventional fixed-gear bicycles have been in existence since around the turn of the century. During that time the basic design has changed very little. The only significant improvements have been in the chain/gearing system. The most successful of these improvements has been the now-familiar derailleur gear-changing system. Other improvements include the coaster brake, the multi-ratio planetary hubs, and the elliptical front sprocket. All of these drive train improvements have added to the roadability and cruising capability of the bicycle, culminating in the now conventional multi-geared (typically ten-speed) bike which is an elegant design having a drive mechanism perfected to nearly 95% efficiency.

The conventional unstreamlined bicycle has a fairly large aerodynamic frontal area and a high drag coefficient. The drag due to wind resistance increases nonlinearly with speed and becomes a substantial limiting factor for the expenditure of less than extreme effort at speeds above 15 or 20 mph. There have been a number of efforts at trying to reduce bicycle/rider wind resistance in order to reduce the effort required to develop better vehicle speeds. Some of the resulting arrangements involve adding a streamlined shell to a bicycle, which has the effect of reducing stability and making the vehicle actually dangerous in cross winds of any noticeable magnitude. Other developments have produced streamlined vehicles in which the rider pedals lying on his stomach with his head forward, a relatively uncomfortable and unsafe arrangement.

A combination of unaffordable fuel costs, dedicated commuting bicycle lanes, and tax incentives is needed before a truly acceptable human powered commuter vehicle is realized.

However, a suitable combination of chassis streamlining, wheel arrangement, propulsion, and roadability is now encapsulated in the present invention to provide an exercise and recreation lifestyle for children, young adults, mature adults, and senior citizens as well as simulating the excitement of race car driving which could become a new niche sport in its own right.

### SUMMARY OF THE INVENTION

The present invention is characterized in the accompanying Abstract, incorporated herein by reference. In brief, a basic arrangement in accordance with the present invention is a fully composite monocoque vehicle having the rider in a supine position. The vehicle includes a fixed rear drive wheel, two steerable front wheels, a set of foot cranks mounted on a drive sprocket for rotational engagement by the rider's feet, a multi-sprocket drive cluster affixed to the chassis and linked by a chain, belt or rigid design to the front sprocket, a mechanism such as a derailleur for shifting the chain to different sprockets in the cluster, freewheeling rollers which direct the chain beneath the rider, a braking mechanism, and a streamlined chassis with an openable transparent canopy for providing entry and egress to the vehicle. The rider sits leaning back, facing forward with his feet extending forward. The rider steers and controls functions such as braking and gear shifting with his hands.

The position of the rider with feet forward and head nearly erect is the most comfortable and preferred position and is much safer in a collision. In addition, the rider can exert greater pedalling force than is possible in the position used with a conventional bicycle. This position also affords the rider excellent visibility to the front and sides. Mirrors can be placed on the outside of the transparent canopy to provide excellent visibility to the rear.

The power train is relatively simple and uses available bicycle components, such as cranks, sprockets, shifters and chain, belt, or rod. The four-wheeled arrangement provides considerably more stability than is possible with a bicycle, particularly with a bicycle which is equipped with a streamlined shell. In addition, the placement of the rider on the chassis at or below the wheel axles greatly lowers the center of gravity.

The aerodynamic design of the streamlined chassis dictates that the chassis is widest at a point approximately 10% of the total length back from the nose. The placement of the two front wheels advantageously develops the optimum compromise of maximum stability with minimal drag. The forward part of the body can be characterized as bullet shaped with a drooped nose. The sides and top of the chassis are gently rounded in continuous curvature at their respective junctures. Aft of the widest part of the body, the chassis is smoothly tapered to a vertical blade-shaped edge at the rear.

The location of the two rear wheels just forward of this rear edge also accords with the compromise of stability and streamlining. The result is a superior combination of vehicle structure—running gear, drive train, rider position, etc.—with a streamlined chassis enclosure which develops improvements in vehicle stability, rider comfort and safety, pedalling effort, aerodynamic drag, and other features which are important to the realization of a satisfactory human-powered vehicle. This improved combination also achieves the capability of higher top speeds, superior to those of vehicles designed by others in attempts to solve the common problem. Preferred embodiments in accordance with the present invention presently hold world speed records for vehicles of this type, having set records in excess of 65 mph for a single-rider vehicle.

The sides and top of the chassis constitute a symmetrical low-drag airfoil. The bottom of the shell enclosure includes a central flat section which is curved and faired to meet the side portions. The chassis totally carries the suspension structure and driver's seat. With a rider placed in such a vehicle, the machine/rider combination has a center of gravity so positioned that all four wheels have approximately equal loading, thus adding to stability and optimum tire wear.

Standard state-of-the art low-drag airfoils are able to maintain laminar fluid flow up to the widest point of their shape. However, if there is any disturbance of the smooth shape of the vehicle's nose, this laminar flow will be lost, and an increase in drag will result. A preferred embodiment of the present invention has no wheels or other disturbing protrusions in the body until nearly the widest point, the place at which the flow is expected to transition naturally from laminar to turbulent flow. Thus, the low drag achieved by this design more closely approaches theoretical low limits. Moreover, the underflow body with curved, faired side edges allows more ground clearance than a straight-sided design of the prior art which extends virtually to the ground in an effort to reduce drag. The present body shape increases roadability without the drag increase associated with a straight-sided design having reasonable road clearance.

In another alternative arrangement, the pair of rear wheels, located opposite each other, are closer together than the front wheels in accordance with the streamlined shape of the shell. Other drive arrangements may be utilized, such as hand-powered or spring motor drives, for example. A compressed air drive may be added, for higher performance without unduly increasing the weight.

There have thus been disclosed herein various embodiments of a human powered vehicle which give promise of satisfying the need for exercise, recreation or the new niche sport of HPV racing which can take the place of the automobile, motorcycle or other motor driven vehicle over reasonable commuting distances. Although pedal-driven and constructed mostly of various parts adapted from the bicycle industry, the vehicle provides safety, comfort, speed and effective range far exceeding the capabilities of the conventional bicycle.

The vehicle has demonstrated its superiority over other attempts to develop human powered vehicles capable of supplanting the standard bicycle. When brought into production, vehicles of the present invention are expected to penetrate substantially the market for exercise, recreation, and racing vehicles.

Although there have been described above specific arrangements of a human-powered vehicle in accordance with the invention for the purpose of illustrating the manner in which the invention may be used to advantage, it will be appreciated that the invention is not limited thereto. Additional features may be incorporated as, for example, small auxiliary power sources such as gas engines or electric motors for longer distance cruising, mechanisms, for regenerative braking and energy storage, and the like. Also a mechanism may be included for canting the rear wheel when crosswinds are encountered, thus developing some forward drive from a sail effect. Accordingly, any and all modifications, variations or equivalent arrangements which may occur to those skilled in the art should be considered to be within the scope of the invention as defined in the claims.

What is claimed is:

1. A vehicle capable of being propelled by a human rider comprising:
a composite monocoque chassis including a seat positioned to support a rider in a generally supine position for operation of the vehicle, four wheels including a pair of front wheels in generally coaxial positions on opposite sides and forward of the seat, and drive means coupled to at least one or two of the rear drive wheels to propel the vehicle in response to rider manipulation; and
a continuous aerodynamic chassis comprising a single monocoque tub totally enclosing the chassis except for wheel wells in the sides of the chassis through which the wheels are suspended, said chassis having its widest dimension at approximately the position of the front wheels and having an aerodynamically shaped section extending forward of the front wheel axis to terminate in a round, elliptical, or parabolic nose.

2. The composite monocoque chassis of claim 1, comprising:
frame walls defining a substantially, unitary chassis, being comprised of:
an interior wall section; an exterior wall section; and, an intermediate layer of reinforcing honeycomb material or woven fiber mat sandwiched between said interior and exterior wall sections; said interior and exterior wall sections each being comprised of a plurality of overlaid layers of composite material, with each individual layer of said composite material being comprised of a multiplicity of unidirectional, small diameter carbon fibers of high modulus and high tensile strength embedded in a resin matrix, said layers being arranged so that the fibers of any one layer cross over the fibers in an adjacent layer; and, the intermediate layer of reinforcing material comprises a synthetic honeycomb material, different from said interior and exterior material, composed of wall segments forming a plurality of cell structures, said wall segments being substantially perpendicular to the unidirectional fibers in said interior and exterior wall sections of said monocoque chassis.

3. The monocoque chassis of claim 1, further comprising a first layer of adhesive between the exterior wall section and layer of honeycomb material.

4. The monocoque chassis of claim 1, further comprising a second layer of adhesive between the layer of honeycomb material and the interior wall section.

5. The monocoque chassis of claim 1, wherein the adhesive is comprised of epoxy.

6. The vehicle of claim 1 having one or two rear drive wheels mounted behind the seat, and wherein the chassis tapers rearwardly from its widest dimension to terminate in a generally triangular, vertical blade-shaped edge behind the rear wheels.

7. The vehicle of claim 2 further including a fixed or removable canopy constituting a portion of the chassis at least partially over the seat, and means for affixing the canopy in position on the remainder of the chassis.

8. The vehicle of claim 1 further including a four point, multi-link, double-wishbone independent suspension structure for attaching the wheels to the chassis.

9. The vehicle of claim 1 wherein the forward portion of the chassis is generally round, elliptical or parabolic-shaped with a drooped nose.

10. The vehicle of claim 5 wherein the locus of points constituting the centers of transverse cross-sections of the nose portion of the chassis define a curve extending downwardly from the longitudinal axis of the chassis.

11. The vehicle of claim 1 wherein the chassis is aerodynamically shaped, and the front wheels are located near the point at which air travelling along the chassis transitions naturally from laminar to turbulent flow.

12. The vehicle of claim 7 wherein the chassis is smooth without any protrusions forward of the point at which air flow transitions naturally from laminar to turbulent flow.

13. The vehicle of claim 1 wherein the front wheels are positioned approximately 10% of the length of the chassis back from the nose.

14. The vehicle of claim 9 wherein the chassis includes an underflow body shape having a central flat surface extending underneath between the front wheels and toward the rear wheels.

15. The vehicle of claim 10 wherein the sides of the chassis and the flat surface are faired into each other along matching curved surfaces generally outboard of the flat surface.

16. The vehicle of claim 1 wherein the chassis includes a central portion on which the seat is mounted.

17. The vehicle of claim 12 further including a personal restraining device mounted on said internal frame sections of chassis, and a roll bar in the form of an inverted U-shaped member extending downwardly on opposite sides of the chassis and attached to the chassis.

18. The vehicle of claim 13 further including means for reasonably mounting the canopy to the chassis.

19. The vehicle of claim 12 wherein the chassis includes a downwardly extending forward portion, and means for mounting the rider responsive drive means thereon.

20. The vehicle of claim 12 wherein the drive means comprises a main drive sprocket rotatably mounted to the forward section of the chassis and having pedal crank means attached thereto, a variable speed driven sprocket affixed to a chassis support, and a drive chain, belt, or rigid means coupling the drive sprocket and one or two of the rear wheels.

21. The vehicle of claim 16 wherein the variable speed sprocket is mounted on the chassis, and further including a plurality of guide pulleys mounted to the chassis for guiding the chain means underneath the seat.

22. The vehicle of claim 12 further including a multi-link, independent, double-wishbone front axle mounted to the chassis forward of the seat and having transverse extending support members for mounting the hubs of the front wheels on opposite sides of the vehicle.

23. The vehicle of claim 18 further including vehicle control steering linkages mounted in front of the seat for access by the rider.

24. The vehicle of claim 19 wherein the control means comprise a steering wheel having a support rod extending downwardly toward the front axle, the support rod being rotatably mounted to the chassis and having means coupled between the upper end of the support rods and the front wheels for steering the vehicle by pivoting the front wheels.

25. The vehicle of claim 19 wherein the control means include means coupled to the drive means for shifting its drive ratio, and means coupled to a wheel braking mechanism for braking the vehicle.

26. The vehicle of claim 16 wherein the drive means include a gear changing lever positioned generally to the right of the seat and having hand knobs for manipulation by a rider's hand to change the drive applied to the main drive sprocket at the pedal crank means.

27. The vehicle of claim 16 wherein the drive means include a gear changing lever positioned generally to the right of the seat and having hand knobs for manipulation by a rider's hand to change the drive applied to the variable speed driven sprocket affixed to the chassis and transmitting the energy to one of the two rear drive wheels.

28. The vehicle of claim 1 further including means inside the chassis for shielding the rider from the wheels.

29. The vehicle of claim 1 further including a chassis extending downwardly from the canopy and generally surrounding the wheel portions at the side of the chassis.

30. The vehicle of claim 1 wherein the wheels include a pair of rear wheels mounted opposite each other within a rear portion of the chassis.

31. The vehicle of claim 1 wherein the chassis having its widest dimension at approximately the position of the front wheels and being faired rearwardly to terminate in a generally vertical, blade-shaped edge behind the rear wheels.

32. A vehicle capable of being propelled by a human rider comprising:
a single, composite, monocoque chassis;
a seat positioned on said chassis for supporting a rider in a generally supine position;
a pair of steerable wheels, suspended from the chassis, and mounted on opposite sides of said chassis forward of said seat;
a pair of rear drive wheels mounted aft of the seat and suspended from the chassis;
a drive sprocket mounted below the axis of the chassis and forward of said steerable wheels and having pedals affixed thereto for rotatably driving the drive sprocket;
a multi-gear sprocket cluster affixed to the chassis;
a chain, belt, or rigid drive extending between the drive sprocket and the sprocket cluster;
a plurality of freewheeling rollers positioned along the chassis to guide the chain underneath the seat; means for pivoting the steerable wheels to steer the vehicle; and
a single, composite monocoque chassis of generally aerodynamic shape totally enclosing the vehicle except for wheelwells in the sides of the chassis through which the wheels are suspended.

33. The vehicle of claim 32 wherein the chassis has its widest dimension approximately at the front wheels.

34. The vehicle of claim 33 wherein the chassis includes a generally round, elliptical, or parabolic-shaped forward portion with a drooped nose extending forwardly of the axis of the front wheels.

35. The vehicle of claim 34 wherein the portion of the chassis forward of the front wheel wells is devoid of any protrusions or other elements which might interfere with laminar air flow along the chassis.

36. The vehicle of claim 35 wherein the chassis tapers rearwardly of its widest dimension to terminate in a generally triangular, vertical, blade-shaped edge at the rear.

37. The vehicle of claim 36 wherein the rear wheels are equilaterally mounted within a narrow portion of the chassis adjacent to the blade-shaped edge at the rear.
